(19) United States
(12) Patent Application Publication
(10) Pub. No.: US 2016/0232605 A1
(43) Pub. Date: Aug. 11, 2016

(54) System and Method for Debt Collection

(71) Applicant: Zhengping Zhang, Alexandria, VA (US)

(72) Inventor: Zhengping Zhang, Alexandria, VA (US)

(21) Appl. No.: 14/616,745

(22) Filed: Feb. 8, 2015

(51) Int. Cl. G06Q 40/02; G06F 17/30

(52) U.S. Cl. CPC G06Q 40/025; G06F 17/30864; G06F 17/3089

(57) ABSTRACT

A web-based, collection law-compliant debt collection system and methods for using the same are disclosed. At its center, the system comprises the databases, processors, and software that form system data storage, website and database management servers, and automatic webpage generators. The center is accessible through the Internet via landline or wireless connections. The system connects all kinds of users and services and enables them to collect debts, negotiate settlements, resolve disputes, exchange information, advertise legal or financial services, and trade debts in a fair, open, and law-compliant manner.

### FIELD OF THE INVENTION

The present invention relates generally to debt collection system and more particularly to a web-based system and method for debt collection.

### BACKGROUND OF THE INVENTION

Debt collection is a multi-billion-dollar industry that directly affects a large number of consumers. To protect the consumers from unlawful debt collection practices, the U.S. Fair Debt Collection Practices Act (FDCPA) and similar laws at state level are enforced. However it is very challenging for small entity creditors, such as individual landlords to whom their formal tenants owe rents, to collect debts with their limited resources. Small entity creditors usually lack the expertise and experience in debt collection, in compliance with the laws, and in legal procedure for judgment. Furthermore, their debt collection would make less business sense because of high costs for using debt collection services or other legal services. Besides, small entity creditors usually do not have easy access to competitive debt trade or collection services. These disadvantages make the debt collection inefficient or unpractical for small creditors, including the large utility companies with a lot of small debt accounts, who would then unwillingly give up.

The FDCPA restricts direct communication of creditors or debt collectors with individual debtors if the latter decline. It is therefore quite challenging, for large or small creditors alike, to collect debts directly from the uncooperative debtors, especially those transient ones who conceal their new contact or location information. For the lack of such information, the creditors or debt collectors are even unable to collect monetary judgments after expensive, time-consuming litigation. Moreover, the FDCPA forbids creditors from disclosing the information about debtors' debts to any third parties without debtors' consent. Since the FDCPA significantly reduces creditors' debt collection power, it is desirable to build a fair, open, and accessible collection system overcoming the obstacles while complying with all the laws.

It would be helpful to connect creditors and the people searching the names of individuals through the Internet for information or curiosity. Among them are debtors themselves, their relatives, neighbors, friends, attorneys, or employers, and authorized entities who conduct their background checks. The concern for their online reputation would motivate debtors to search online; and the communication initiated or authorized by debtors would always be in compliance with the FDCPA. Moreover, without any disclosure about debts, the acquisition of debtors' location information from third parties is allowed by the law. Furthermore it would be mutually beneficial that the authorized entities, such as prospective landlords, share and exchange relevant information with creditors. In the prior art, however, no system provides such useful connections.

Therefore, it is desirable to build a FDCPA-compliant, web-based system that enables creditors to store the information about debtors and debts, enables the debt information to be fully accessible and searchable except the debtors' identities, enables debt purchasers, service providers, or debtors to contact creditors, enables the names of the debtors to be publicly searchable without indications of their debts, enables creditors to exchange information about debtors with authorized entities, and enables debtors to dispute or negotiate with creditors. Such a system would establish cost-efficient, effective communication, information exchange, and business between creditors and interested third parties and encourage debtors to solve their debt problems with creditors.

Accordingly, these are the objects and advantages of the present invention. Further objects and advantages will become apparent after consideration of the following detailed description and drawings.

### SUMMARY OF THE INVENTION

A web-based system allows creditors to input and store debtors' account information and enables all users—creditors, collection service providers, debt purchasers, legal service professionals, information querists, and debtors—to communicate with each other for collecting debts, negotiating settlements, resolving disputes, trading debts, exchanging information, and providing legal or financial services in fair, open, and FDCPA-compliant manners. At its center, the system comprises the computer databases, hardware, and software that form data storage, servers, automatic webpage generators, and landline or wireless connection with the Internet.

The webpage generator automatically creates one webpage for each debtor recorded in the database. The webpages for persons or individuals do not reveal their debt information other than their names and locations while the ones for business entities disclose detailed information. All the webpages are searchable at least by the unique queries—the names of either persons or entities—on the Internet or the home page of the system's website. Creditors can be contacted through hyperlinks in the webpages. The creditors who have one same debtor automatically form closer relationships, as “friends”, to exchange or consolidate the debtor's information. Authorized querists may submit debtor's written authorizations to and exchange debtors' information with creditors. However, unauthorized querists cannot obtain the debt information from the system except providing creditors with certain information about the debtors that they know well as “neighbors.” Debtors may initiatively communicate with creditors to pay their debts, make payment plans, or negotiate settlements using the hyperlinks. After the debt problems are solved, the creditors submit requests for the removals of related debt records. The system processes the requests, removes the records from the database, and updates the corresponding webpages. When all the debt records associated with a debtor are removed, the webpage associated with the name of the debtor is deleted. Debtors can dispute their debts through a forum of the system by initiating new topics or “threads” on the debts and submitting their evidence. The forum is open to all registered users of the system. Collection and legal service professionals are allowed to access the information about the debt accounts in dispute and to comment on the disputes. All registered users except debtors can poll on which side in a dispute more trustful. If predetermined critical votes are met in favor of a debtor, the relevant debt record is removed from the system with no creditor's consent provided that the creditor fails to submit new evidence to support the original claim. Debt purchasers may login the system to search all the debt records except the persons' names. There are advertisement spaces on the webpages, open to the public and preferable to debts related services, such as debt collectors, lawyers, and financial advisors. And legal information or advice is provided by the system to users during all the communications.

The following detailed description together with the accompanying drawings will provide a better understanding of the nature and advantages of the present invention.

### BRIEF DESCRIPTION OF DRAWINGS

FIG. 1 depicts central components of a debt collection system according to an embodiment of the present invention.

FIG. 2 depicts a debt collection system according to an embodiment of the present invention.

FIG. 3 depicts alternative configuration of the central components shown in FIG. 1 according to an embodiment of the present invention.

FIG. 4 depicts alternative central components of a debt collection system according to an embodiment of the present invention.

### DETAILED DESCRIPTION

### Preferred Embodiment

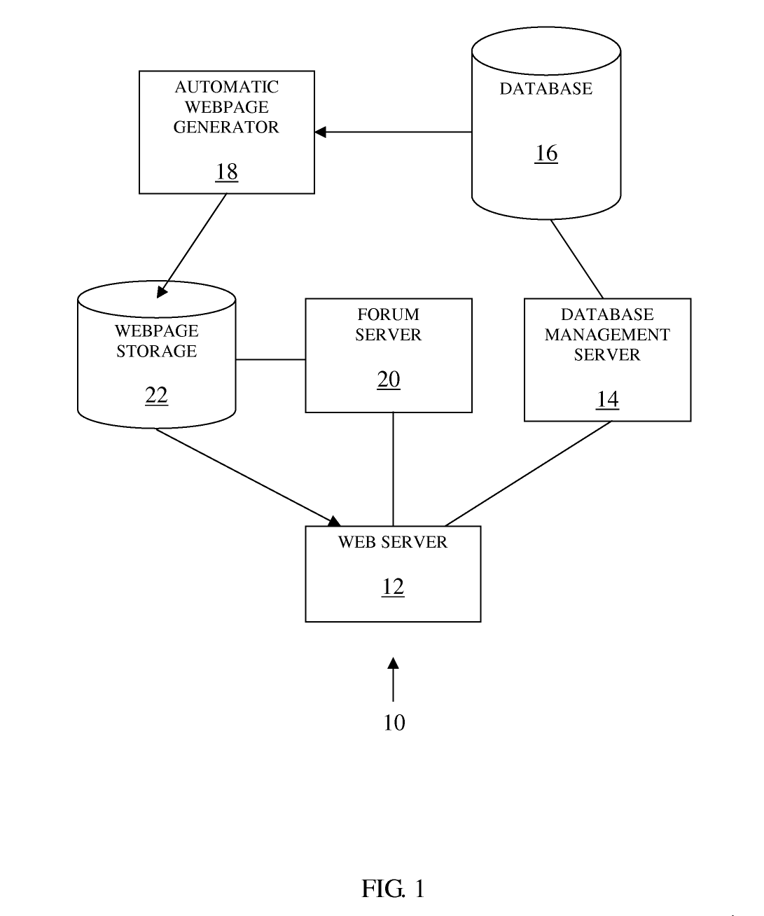

FIG. 1 depicts exemplary components of a debt collection center 10 according to a preferred embodiment of the present invention. Debt collection center 10 is established to run an open yet FDCPA-compliant collection system and implemented with a database and computer hardware and software. As shown in FIG. 1, debt collection center 10 generally comprises a web server 12, a database management server 14, a database 16, an automatic webpage generator 18, a forum server 20, and a webpage storage 22 consisted of a computer storage medium or memory. Web server 12, having a means for accessing the Internet (not shown, such as a modem, network card, or other similar networking device) to transfer data via landline or wireless connection, receives debt data and handles online queries or requests. The debt data are verified or consolidated through management server 14 and are stored into database 16; and the requests are forwarded to management server 14 or forum server 20 if necessary. The receipt of the debt data triggers automatic webpage generator 18 to create new webpages, which are stored to webpage storage 22 and posted on the Internet through web server 12. The created webpages are FDCPA-compliant by the use of different predetermined templates depending on entities.

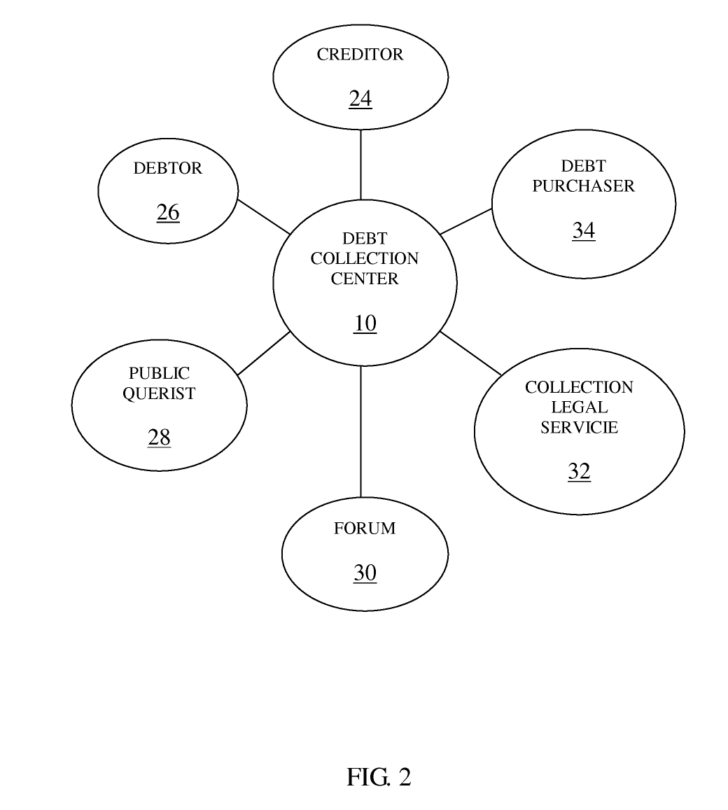

FIG. 2 depicts a debt collection system according to a preferred embodiment of the present invention. Through web server 12, debt collection center 10 is in communication with a creditor 24, a debtor 26, a querist 28, a forum 30, a collection or legal service 32, and a debt purchaser 34. Using a web browser, creditor 24 subscribes or registers to collection center 10 by a password protection or user authentication scheme and enters the data of one or more debtors' accounts into database 16 through web server 12 and management server 14. For the creditors having the same debtor, a close group relationship, as of “friends,” is automatically established to share, exchange, distinguish or consolidate all the information about the debtor among the group. The data entries trigger off the creation of new webpages or the update of existing ones.

One of predetermined web templates is automatically chosen for the creation of a new webpage depending on debtors. If a debtor is a person, the webpage discloses the debtor's full name and last known location or where the debt incurred (i.e. city/county, state and zip code), with no indication of the debt, neither explicitly nor implicitly. On the webpage, there is a hyperlink to a HTML form which inputs and attachments are sent to the creditor through email or email-forwarding; its hypertext indicates that someone holds information about the named one or that someone is seeking communication with the named one. However, if the debtor is a company, the webpage discloses more information about it and its debt. Therefore, such created webpages are FDCPA-compliant and searchable by the names of debtors and maintain accessible communication channels to corresponding creditors. On the HTML form and by its radio button, drop-down list, select box, or check box, users are required to choose one of the predefined categories—being the person or entity that the webpage is about, holding information about the person or entity, or seeking information about the person or entity. And a completed form is validated upon submission by requiring certain document as an attachment to support the user's claim; the creditor is also advised by debt collection center 10 about how to respond accordingly for compliance with laws.

Because of their curiosity about or concern for the information about themselves online, debtors 26 may search the Internet for their own names with web browsers, and find the webpages associated with their names. The debtors may initiate communication with creditors, using the hyperlinks on the webpages, to obtain more information or request the creditors to remove the webpages. At the beginning of the communications, the debtors may be asked to identify themselves by providing collection center 10 with certain personal information, such as last 4 digits of their social security numbers, which is verified by matching the information stored in database 16. The debtors may solve their debt problems by paying their debts or negotiating payment plans or settlements with the creditors. Upon the completion of the payment or settlements, the creditors can submit requests for removal of the corresponding debt accounts or records from database 16. The requests are received at web server 12 and passed to management server 14 for processing. After certain verification and authorization processes, database 16 is updated by deleting the corresponding debt records. Accordingly the associated webpages are updated by webpage generator 18, in response to the database updating, by deleting the corresponding hyperlinks or removing the webpages as whole if all the hyperlinks thereon are deleted. Therefore, the debt collection system can have debtors well informed with no direct calls and enable them to initiate initiatively the communications with their creditors about their debts at their convenience.

Debtors 26 may openly dispute their debts through forum 30 hosted by debt collection center 10. The forum is similar to the Internet forums or message boards as well-known in the art but only open to the subscribed or registered users of the debt collection system. Forum server 14 creates and organizes different topics or “threads,” which are archived in webpage storage 22. Only can a registered debtor initiate a topic or thread on the debt; and the debtor's initiation authorizes the system to allow the creditor to disclose detailed debt information on the forum. Both sides are allowed to post their evidence relating to the debt account in dispute. Upon request, a system administrator may decide whether to remove the disputed account basing on the evidence. Also collection or legal service 32 and debt purchaser 34 are allowed to comment or advise on the forum. Basing on the posted evidence and the experts' comments or opinions, all registered users except debtors can poll on whether the debt account in dispute should be removed. When predetermined critical votes are reached in favor of the debtor, the disputed account is removed by collection center 10 without the creditor's consent provided that there is no new evidence to support the creditor after the poll.

Querist 28 could be anyone who is interested in searching the Internet for information with queries of the names of persons or entities, including a debtor's relative, friend, neighbor, or coworker or an authorized person conducting a background check for the purpose of housing, employment or loan. At the beginning of the communication with a creditor through a hyperlink on a webpage, querist 28 is required to classify his or her self by choosing one of the predefined categories shown on the HTML form and submit a supporting document as required. An authorized querist, such as a prospective landlord having an application from a prospective tenant, is required to attach a copy of a written authorization and send it to the creditor by submission of the form. After receiving the proof of authorization, the creditor can fully disclose the information about the debtor and/or debt to the querist without violating the FDCPA. Such information exchange and disclosure would benefit both sides: the creditor can obtain current location information about the debtor and the querist can inquire the debt or background information. After the communication, the creditor may update the corresponding debt account. However, an unauthorized querist who does not have or submit any written authorizations would be treated only as a “neighbor” or friend of the debtor and be allowed to provide certain information about the debtor but not acquire any debt information.

Collection or legal service 32 represents a variety of collection or legal service providers or professionals, such as debt collection companies, financial advisors, lawyers, or skip tracing professionals. In the debt collection system, such companies or professionals may advertise their services in the advertisement spaces of the webpages, provide their services for creditors or debtors, and provide their judgment and opinions on forum 30. On the basis of the debtors' account information, the debt collection system enables collection or legal service 32 to target the prospective clients in preferred areas or with selected attributes.

Debt purchaser 34 represents the companies or individuals who are interested in acquiring certain debt ownerships. After registering with debt collection center 10, through web server 12 and management server 14, such purchasers may request and search all kinds of lists or views for debt account records in database 16 excluding debtors' names. In compliance with the FDCPA, the lists actually provide all debt information necessary for debt trading. Therefore the concealment of the debtors' names does not affect the business between debt purchasers and creditors before final transaction. As mentioned previously, the debt purchasers' judgment or opinions are appreciated on forum 30, because of the nature of debt purchasers' business.

### CONCLUSION, RAMIFICATIONS, AND SCOPE

The present invention accomplishes its stated objectives. A number of advantages of the present invention, from the description above, is evident:
It is an open yet FDCPA-compliant system for debt collection and service.
It enables and motivates debtors to initiate communication with their creditors to solve their debt problems initiatively.
It specially benefits small creditors, including individuals and big companies having a large number of individual debt accounts with small amounts.
It enables authorized users to obtain certain background information easily.
It helps creditors obtain current location information about their debtors.
It enables debtors to dispute their debts in a direct, fair, easy, and transparent way.
It makes debt collection and legal services to be conveniently and easily accessible to creditors.
It provides collection and legal service companies and professionals with easier way and good opportunity to find prospective clients in their preferred areas.

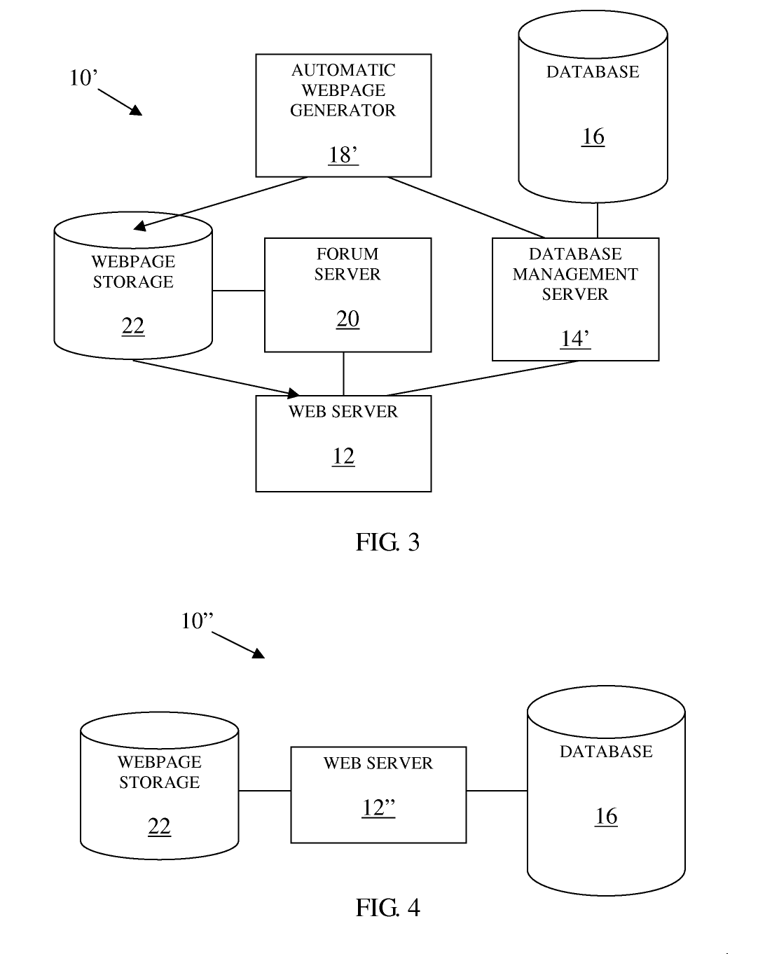

While the above description of the debt collection system shown in FIGS. 1-2 contains many specificities, they should not be construed as limitations on the scope of the present invention, but exemplifications of the preferred embodiments thereof. Many other ramifications and variations are possible within the teachings of the various embodiments. At the collection center, webpage generator 18 may be replaced by an alternative generator 18′ that is triggered by a database management server 14′ as shown in FIG. 3, instead of by database 16 as shown in FIG. 1. Management servers 14′ and 14 may be different in software. Furthermore, all the servers may be integrated into one, as shown in FIG. 4, by an alternative web server 12″ having all the functions of the servers; and database 16 and webpage storage 22 may be also integrated (not shown). Here are more examples: 1) supplementary computer hardware and/or software, not described in above description, perform locally or remotely conventional system administration and maintenance, such as backups for servers and database; 2) debt account data could be transferred locally from portable data storage means, such as CDs, into the database through database management server 14 or through other local electronic devices or computers (not shown), especially for the creditors owning a large amount of debt account data; 3) there are more inter communication methods between the system's users other than emailing, such as by phone calling, texting, or instant messaging; 4) users access the system using the web browsers on their smart phones or other portable devices, instead of the web browsers on their computers; 5) the system provides a homepage having a drop-down name list or fill-up query field for showing or finding the webpages; 6) registered users retrieve creditors' contact information from the database for communication with creditors, in addition to through the hyperlinks on the webpages; 7) the system provides a online payment service to aid debt payment and business transaction, as known in the art; and 8) creditors are advised about how to comply with the FDCPA when combining the system with a conventional collection method, such as making direct calls to debtors. Thus the scope of the present invention should be determined not by the examples given but by the appended claims and their legal equivalents.

I claim:

1. A method for aiding debt collection, comprising the steps of:
receiving data of a debt that comprise the name of a debtor and the contact information of a creditor, storing said data in a database, creating or updating a webpage that contains said name and contains a hyperlink for communication with said creditor, and posting said webpage to make it searchable by said name on the Internet.

2. The method of claim 1 wherein said step of creating or updating is implemented by an automatic means triggered by said step of storing.

3. The method of claim 1 wherein said data is provided by said creditor remotely or transferred from a storage medium locally.

4. The method of claim 1 wherein said step of updating comprises adding said hyperlink into said webpage.

5. The method of claim 1 wherein the content of said webpage is in compliance with laws, such as no indications of said debt if said debtor is a person.

6. The method of claim 3 wherein said storage medium is a computer memory, tape, compact disc, or hard drive or another database.

7. The method of claim 5 wherein said hyperlink points to a HTML form which inputs and attachments can be submitted to said creditor through an electronic means.

8. The method of claim 7, further including the step of:
providing one or more remote viewers with a plurality of views of the debt information stored in said database comprising said data except said name.

9. The method of claim 7, further including the steps of:
querying, on said HTML form, which of predefined categories a user belongs to, requiring said user to attach necessary supporting information or document to said HTML form, and advising said creditor how to respond to said user for complying with said laws along with the submission of said HTML form.

10. The method of claim 8, further including the steps of:
creating an online forum that enables said debtor to initiate a dispute about said debt with said creditor and to submit relevant evidence, polling said remote viewers on said dispute, and removing accordingly the record of said debt from said database if the votes in favor of said debtor reach a predetermined number.

11. The method of claim 8, further including the steps of:
creating one or more advertisement spaces in said webpage, and providing an online payment service,
whereby said remote viewers may advertise their services in said one or more advertisement spaces and said debtor may pay said debt through said online payment service.

12. A method for debt collection, comprising the steps of:
receiving, at a web server, data of a debt that comprise the name of a debtor and the contact information of a creditor from said creditor, entering said data into a database, and providing the debt records of said database excluding the debtors' names in response to a query,
whereby one or more queriers can review said debt records, obtain the contact information of the creditors, and communicate with said creditors for debt trade, collection service, or legal service while there is no violation to laws.

13. The method of claim 12, further including the steps of:
creating or updating a webpage that contains said name and contains a hyperlink for communication with said creditor, and posting, through said web server, said webpage to make it searchable with said name on the Internet,
whereby said debtor may find said webpage and initiate said communication to pay said debt.

14. The method of claim 13 wherein there is no indication of said debt on said webpage when said debtor is an individual.

15. The method of claim 14, further including the steps of:
creating an Internet forum to enable said debtor to dispute said debt, polling said queriers on the dispute, deciding whether to delete the record of said debt from said database on the basis of the poll result, and deleting said record and hyperlink or said webpage if said hyperlink is the last one thereon when the decision is in favor of said debtor.

16. The method of claim 14 wherein said hyperlink points to a web form that requires one querier to select one category from predefined querier categories, further including the steps of:
validating said web form by requiring said one querier to attach necessary supporting information or documents for the selection, providing said creditor with an advice about how to respond to said one querier for complying with said laws along with the submission of said web form, and sending said creditor the input and attachment to said web form through e-mail or e-mail forwarding,
whereby said one querier can be verified by said creditor before disclosing or exchanging the information about said debtor or debt.

17. The method of claim 16, further including the steps of:
creating a main web page, hosted by said web sever, that comprises a drop-down list or search field, making said webpage searchable by said name in said drop-down list or search field, and posting said main web page on the Internet.

18. A system for debt collection, comprising:
a processor, a memory in communication with said processor, a database operatively coupled with said processor, and a means for accessing an electronic network in communication with said processor; said memory comprising a data management module, a webpage creation module, and a web management module; said data management module, executable by said processor, programmed to receive data of a debt that comprise the name of a debtor and the contact information of a creditor and to store said data into said database; said webpage creation module, executable by said processor, programmed to be automatically executed, in response to the receipt of said data, to create or update a webpage that contains said name and contains a hyperlink to a HTML form for submission to said creditor through email or email-forwarding; said web management module, executable by said processor, programmed to post said webpage on the Internet through said means.

19. The system of claim 18, further including:
said web management module additionally programmed to receive an input from a remote browser of a user and send an output to said user through said means; said data management module additionally programmed to register said user by a user authentication scheme and to retrieve the debt records without the debtor's name attribute from said database upon the request of said user received through said web management module.

20. The system of claim 19, further including:
said HTML form containing a selection of predefined user categories for said user to select, said webpage creation module additionally programmed to enable said HTML form to validate a submission thereof by requiring said user to attach necessary information or document in supporting the claim for the category selected by said user and programmed to advise said creditor how to respond to said user in complying with laws.
